(19) United States
(12) Patent Application Publication
(10) Pub. No.: US 2015/0140275 A1
(43) Pub. Date: May 21, 2015

(54) FLEXIBLE HEAT SEALED DECORATIVE ARTICLES HAVING A SUPPORT LAYER AND METHODS OF MAKING THE SAME

(71) Applicant: High Voltage Graphics, Inc., Fort Collins, CO (US)

(72) Inventor: Louis Brown Abrams, Fort Collins, CO (US)

(21) Appl. No.: 14/542,128

(22) Filed: Nov. 14, 2014

Related U.S. Application Data
(60) Provisional application No. 61/904,923, filed on Nov. 15, 2013.
(60) Provisional application No. 61/908,617, filed on Nov. 25, 2013.
(60) Provisional application No. 61/920,636, filed on Dec. 24, 2013.

(51) Int. Cl. B32B 3/26; B32B 27/36; B32B 7/12; B32B 27/40; B44C 1/10; B32B 5/02

(52) U.S. Cl. CPC B32B 3/263; B44C 1/105; B32B 5/024; B32B 5/026; B32B 7/12; B32B 27/40; B32B 27/365; B32B 2250/03; B32B 2451/00
USPC 428/161; 156/60

(57) ABSTRACT

Various decorative articles and methods of manufacturing the same are described. In particular, decorative articles having a support layer and an adhesive. The support layer is positioned between a decorative element and a substrate having a surface disruption. When the support layer is adhered to the substrate by an adhesive, the combination of the support layer and adhesive blocks any imaging of the surface disruption within the decorative element.

### CROSS REFERENCE TO RELATED APPLICATIONS

The present application claims the benefits of U.S. Provisional Application Serial Nos. 61/904,923 filed Nov. 15, 2013, 61/908,617 filed Nov. 25, 2013 and 61/920,636 filed Dec. 24, 2013, each entitled “Flexible Heat Sealed Decorative Articles and Method for Making the Same” and each of which is incorporated herein by this reference in its entirety.

### FIELD

The present disclosure is directed generally to decorative articles and specifically to mixed media decorative articles having a support layer.

### BACKGROUND

People for many years have created decorative articles composed of contrasting materials, special effects, prints, and the like. These decorative articles have included flock, woven or knit textiles, metallized films such as those sold by Plus Corporation under the tradename PRIST™. While these decorative articles are attractive to viewers, they generally, when adhered to a substrate, are compliant with surface disruptions (such as seams, irregularities, textural attributes, as for example) of the substrate. The compliant nature of the decorative article can cause the surface disruptions to be imaged through the decorative element and be visible within the decorative element. For example, when a decorative element adhered across a seam of garment, the compliant nature of the decorative element can cause the image of the seam to be visible within the decorative element.

There is, therefore, a need for a new class of decorative articles meeting the more stringent aesthetics requirements of today's society.

### SUMMARY

These and other needs are addressed by the various embodiments and configurations of the present disclosure. This disclosure generally relates to decorative articles having a support layer. When the support layer is positioned between a decorative element and a substrate having a surface disruption, the support layer blocks any reproductive imaging of the surface disruption within the decorative element.

In accordance with a first embodiment is an appliqué article having support layer positioned between first and second adhesives and a decorative element adhered to the first adhesive.

In some configurations of the first embodiment, the decorative element is selected from the group consisting of flock, a woven textile, a knitted textile, a metalized film, or a combination thereof.

In some configurations of the first embodiment, the support layer has a support layer areal extent.

In some configurations of the first embodiment, the second adhesive has a second adhesive areal extent.

In some configurations of the first embodiment, the support layer areal extent and the second adhesive areal extent are substantially equal.

In some configurations of the first embodiment, the decorative element has a decorative element areal extent, the decorative element areal being substantially equal to the support layer areal extent.

In some configurations of the first embodiment, the support layer has a tensile strength from about 55 to about 75 MPa.

In some configurations of the first embodiment, the support layer has a tensile modulus from about 1,800 to about 2,400 MPa.

In some configurations of the first embodiment, the support layer has a thickness from about 0.1 to 0.8 mm.

In some configurations of the first embodiment, the support layer has a softening temperature greater than 145 degrees Celsius.

In some configurations of the first embodiment, the support layer is a polymeric material.

In some configurations of the first embodiment, the support layer comprises polycarbonate.

In some configurations of the first embodiment, the decorative element is flock.

In some configurations of the first embodiment, the decorative element is a woven textile.

In some configurations of the first embodiment, the decorative element is a knitted textile.

In some configurations of the first embodiment, the decorative element is a metalized film.

In some configurations of the first embodiment, the decorative element is a combination of two of the flock, woven textile, knitted textile, and metalized film.

In some configurations of the first embodiment, the decorative element is a combination of two of the flock, woven textile, knitted textile, and metalized film having the two of the flock, woven textile, knitted textile, and metalized film are arranged side by side.

In some configurations of the first embodiment, the decorative element is a combination of two of the flock, a woven textile, a knitted textile, and a metalized film having the two of the flock, woven textile, knitted textile, and metalized film are arranged one on top of the another.

In some configurations of the first embodiment, the decorative element is a combination of two or more of the flock, woven textile, knitted textile, and metalized film.

In some configurations of the first embodiment, the decorative element is a combination of two or more of the flock, woven textile, knitted textile, and metalized film having at least two of the two or more of the flock, woven textile, knitted textile, and metalized film are arranged side by side.

In some configurations of the first embodiment, the decorative element is a combination of two or more of the flock, woven textile, knitted textile, and metalized film having at least two of the two or more of the flock, woven textile, knitted textile, and metalized film are arranged one on top of the another.

In some configurations of the first embodiment, the first adhesive is positioned between the decorative element and the support layer and the first adhesive is one of a thermoplastic or thermosetting adhesive.

In some configurations of the first embodiment, the second adhesive is one of a thermoplastic or thermosetting adhesive.

In some configurations of the first embodiment, the flock is sublimation dyed.

In some configurations of the first embodiment, the woven textile is sublimation dyed.

In some configurations of the first embodiment, the knitted textile is sublimation dyed.

In some configurations of the first embodiment, the metalized film is polyurethane.

In some configurations of the first embodiment, the metalized film is engraved.

In some configurations of the first embodiment, a release adhesive is positioned between a carrier sheet and a first surface of the decorative element.

In some configurations of the first embodiment, a second surface of the decorative element is adhered to the first adhesive, the first and second surfaces of the decorative element being in an opposing relationship.

It can be appreciated that one or more of the configurations of the first embodiment can be combined in any manner or order.

In accordance with a second embodiment is an article having a decorative element, a support layer positioned between first and second adhesives, and a substrate having a surface disruption. The second adhesive is positioned between the substrate and the support layer. Furthermore, the second adhesive is in contact with the surface disruption. The first adhesive is positioned between the decorative element and the support layer.

In some configurations of the second embodiment, the decorative element is selected from the group consisting of flock, a woven textile, a knitted textile, a metalized film, or a combination thereof.

In some configurations of the second embodiment, the support layer has a support layer areal extent.

In some configurations of the second embodiment, the second adhesive has a second adhesive areal extent.

In some configurations of the second embodiment, the support layer areal extent and the second adhesive areal extent are substantially equal.

In some configurations of the second embodiment, the decorative element has a decorative element areal extent, the decorative element areal extent being substantially equal to the support layer areal extent.

In some configurations of the second embodiment, the support layer has a tensile strength from about 55 to about 75 MPa.

In some configurations of the second embodiment, the support layer has a tensile modulus from about 1,800 to about 2,400 MPa.

In some configurations of the second embodiment, the support layer has a thickness from about 0.1 to 0.8 mm.

In some configurations of the second embodiment, the support layer has a softening temperature greater than 145 degrees Celsius.

In some configurations of the second embodiment, the substrate is an item of apparel.

In some configurations of the second embodiment, the substrate is a garment.

In some configurations of the second embodiment, the substrate is a consumer product.

In some configurations of the second embodiment, the substrate is an item of apparel and the surface disruption is a seam.

In some configurations of the second embodiment, the surface disruption does not telegraph through to the decorative element.

In some configurations of the second embodiment, the surface disruption is not imaged within the decorative element.

In some configurations of the second embodiment, the surface disruption extends above the substrate surface.

In some configurations of the second embodiment, the surface disruption extends below the substrate surface.

In some configurations of the second embodiment, the surface disruption is not imaged within the decorative element and is not perceived by a viewer of the decorative element.

In some configurations of the second embodiment, the support layer is a polymeric material.

In some configurations of the second embodiment, the support layer is polycarbonate.

In some configurations of the second embodiment, the decorative element is flock.

In some configurations of the second embodiment, the decorative element is a woven textile.

In some configurations of the second embodiment, the decorative element is a knitted textile.

In some configurations of the second embodiment, the decorative element is a metalized film.

In some configurations of the second embodiment, the decorative element is a combination of two of the flock, woven textile, knitted textile, and metalized film.

In some configurations of the second embodiment, the decorative element is a combination of two of the flock, woven textile, knitted textile, and metalized film having the two of the flock, woven textile, knitted textile, and metalized film are arranged side by side.

In some configurations of the second embodiment, the decorative element is a combination of two of the flock, a woven textile, a knitted textile, and a metalized film having the two of the flock, woven textile, knitted textile, and metalized film are arranged one on top of the another.

In some configurations of the second embodiment, the decorative element is a combination of two or more of the flock, woven textile, knitted textile, and metalized film.

In some configurations of the second embodiment, the decorative element is a combination of two or more of the flock, woven textile, knitted textile, and metalized film having at least two of the two or more of the flock, woven textile, knitted textile, and metalized film are arranged side by side.

In some configurations of the second embodiment, the decorative element is a combination of two or more of the flock, woven textile, knitted textile, and metalized film having at least two of the two or more of the flock, woven textile, knitted textile, and metalized film are arranged one on top of the another.

In some configurations of the second embodiment, the first adhesive is positioned between the decorative element and the support layer and the first adhesive is one of a thermoplastic or thermosetting adhesive.

In some configurations of the second embodiment, the second adhesive is one of a thermoplastic or thermosetting adhesive.

In some configurations of the second embodiment, the flock is sublimation dyed.

In some configurations of the second embodiment, the woven textile is sublimation dyed.

In some configurations of the second embodiment, the knitted textile is sublimation dyed.

In some configurations of the second embodiment, the metalized film is polyurethane.

In some configurations of the second embodiment, the metalized film is engraved.

It can be appreciated that one or more of the configurations of the second embodiment can be combined in any manner or order.

In accordance with a third embodiment is a transfer having a decorative element, a release adhesive positioned between a carrier sheet and a first surface of the decorative element, a support layer positioned between first and second adhesives, and a second surface of the decorative element is adhered to the first adhesive, the first and second surfaces of the decorative element being in an opposing relationship.

Some configurations of the third embodiment include a substrate having a surface disruption. In some configurations, the surface disruption extends above the surface of substrate. In some configurations, the surface disruption extends below the surface of substrate.

In some configurations of the third embodiment, the decorative element is selected from the group consisting of flock, a woven textile, a knitted textile, a metalized film, or a combination thereof.

In some configurations of the third embodiment, the support layer has a support layer areal extent.

In some configurations of the third embodiment, the second adhesive has a second adhesive areal extent.

In some configurations of the third embodiment, the support layer areal extent and the second adhesive areal extent are substantially equal.

In some configurations of the third embodiment, the decorative element has a decorative element areal extent, the decorative element areal being substantially equal to the support layer areal extent.

In accordance with some configurations of the third embodiment, the support layer has a tensile strength from about 55 to about 75 MPa.

In accordance with some configurations of the third embodiment, the support layer has a tensile modulus from about 1,800 to about 2,400 MPa.

In accordance with some configurations of the third embodiment, the support layer has a thickness from about 0.1 to 0.8 mm.

In accordance with some configurations of the third embodiment, the support layer has a softening temperature greater than 145 degrees Celsius.

In accordance with some configurations of the third embodiment, the second adhesive is positioned between the substrate and the support layer in contact with the surface disruption and the first adhesive is positioned between the decorative element and the support layer.

In accordance with some configurations of the third embodiment, the substrate is an item of apparel.

In accordance with some configurations of the third embodiment, the substrate is a garment.

In accordance with some configurations of the third embodiment, the substrate is a consumer product.

In accordance with some configurations of the third embodiment, the substrate is an item of apparel and the surface disruption is a seam.

In accordance with some configurations of the third embodiment, the surface disruption does not telegraph through to the decorative element.

In accordance with some configurations of the third embodiment, the surface disruption is not imaged within the decorative element.

In accordance with some configurations of the third embodiment, the surface disruption is not imaged within the decorative element and is not perceived by a viewer of the decorative element when the carrier sheet is removed from the transfer.

In some configurations of the third embodiment, the support layer is a polymeric material.

In some configurations of the third embodiment, the support layer is polycarbonate.

In some configurations of the third embodiment, the decorative element is flock.

In some configurations of the third embodiment, the decorative element is a woven textile.

In some configurations of the third embodiment, the decorative element is a knitted textile.

In some configurations of the third embodiment, the decorative element is a metalized film.

In some configurations of the third embodiment, the decorative element is a combination of two of the flock, woven textile, knitted textile, and metalized film.

In some configurations of the third embodiment, the decorative element is a combination of two of the flock, woven textile, knitted textile, and metalized film having the two of the flock, woven textile, knitted textile, and metalized film are arranged side by side.

In some configurations of the third embodiment, the decorative element is a combination of two of the flock, a woven textile, a knitted textile, and a metalized film having the two of the flock, woven textile, knitted textile, and metalized film are arranged one on top of the another.

In some configurations of the third embodiment, the decorative element is a combination of two or more of the flock, woven textile, knitted textile, and metalized film.

In some configurations of the third embodiment, the decorative element is a combination of two or more of the flock, woven textile, knitted textile, and metalized film having at least two of the two or more of the flock, woven textile, knitted textile, and metalized film are arranged side by side.

In some configurations of the third embodiment, the decorative element is a combination of two or more of the flock, woven textile, knitted textile, and metalized film having at least two of the two or more of the flock, woven textile, knitted textile, and metalized film are arranged one on top of the another.

In some configurations of the third embodiment, the first adhesive is positioned between the decorative element and the support layer and the first adhesive is one of a thermoplastic or thermosetting adhesive.

In some configurations of the third embodiment, the second adhesive is one of a thermoplastic or thermosetting adhesive.

In some configurations of the third embodiment, the flock is sublimation dyed.

In some configurations of the third embodiment, the woven textile is sublimation dyed.

In some configurations of the third embodiment, the knitted textile is sublimation dyed.

In some configurations of the third embodiment, the metalized film is polyurethane.

In some configurations of the third embodiment, the metalized film is engraved.

It can be appreciated that one or more of the configurations of the third embodiment can be combined in any manner or order.

In accordance with a fourth embodiment is a transfer having a decorative element, a release adhesive positioned between a carrier sheet and a first surface of the decorative element, a support layer positioned between first and second adhesives, a substrate having a surface disruption, and a second surface of the decorative element is adhered to the first adhesive, the first and second surfaces of the decorative element being in an opposing relationship. The second adhesive is positioned between the substrate and the support layer in contact with the surface disruption.

In some configurations of the fourth embodiment, the surface disruption extends above the surface of substrate.

In some configurations of the fourth embodiment, the surface disruption extends below the surface of substrate.

In some configurations of the fourth embodiment, the first adhesive is positioned between the decorative element and the support layer.

In some configurations of the fourth embodiment, the decorative element is selected from the group consisting of flock, a woven textile, a knitted textile, a metalized film, or a combination thereof.

In some configurations of the fourth embodiment, the support layer has a support layer areal extent.

In some configurations of the fourth embodiment, the second adhesive has a second adhesive areal extent.

In some configurations of the fourth embodiment, the support layer areal extent and the second adhesive areal extent are substantially equal.

In some configurations of the fourth embodiment, the decorative element has a decorative element areal extent, the decorative element areal being substantially equal to the support layer areal extent.

In accordance with some configurations of the fourth embodiment, the support layer has a tensile strength from about 55 to about 75 MPa.

In accordance with some configurations of the fourth embodiment, the support layer has a tensile modulus from about 1,800 to about 2,400 MPa.

In accordance with some configurations of the fourth embodiment, the support layer has a thickness from about 0.1 to 0.8 mm.

In accordance with some configurations of the fourth embodiment, the support layer has a softening temperature greater than 145 degrees Celsius.

In some configurations of the fourth embodiment, the substrate is an item of apparel.

In accordance with some configurations of the fourth embodiment, the substrate is a garment.

In some configurations of the fourth embodiment, the substrate is a consumer product.

In some configurations of the fourth embodiment, the substrate is an item of apparel and the surface disruption is a seam.

In some configurations of the fourth embodiment, the surface disruption does not telegraph through to the decorative element.

In some configurations of the fourth embodiment, the surface disruption is not imaged within the decorative element.

In some configurations of the fourth embodiment, the surface disruption is not imaged within the decorative element and is not perceived by a viewer of the decorative element when the carrier sheet is removed from the transfer.

In some configurations of the fourth embodiment, the support layer is a polymeric material.

In some configurations of the fourth embodiment, the support layer is polycarbonate.

In some configurations of the fourth embodiment, the decorative element is flock.

In some configurations of the fourth embodiment, the decorative element is a woven textile.

In some configurations of the fourth embodiment, the decorative element is a knitted textile.

In some configurations of the fourth embodiment, the decorative element is a metalized film.

In some configurations of the fourth embodiment, the decorative element is a combination of two of the flock, woven textile, knitted textile, and metalized film.

In some configurations of the fourth embodiment, the decorative element is a combination of two of the flock, woven textile, knitted textile, and metalized film having the two of the flock, woven textile, knitted textile, and metalized film are arranged side by side.

In some configurations of the fourth embodiment, the decorative element is a combination of two of the flock, a woven textile, a knitted textile, and a metalized film having the two of the flock, woven textile, knitted textile, and metalized film are arranged one on top of the another.

In some configurations of the fourth embodiment, the decorative element is a combination of two or more of the flock, woven textile, knitted textile, and metalized film.

In some configurations of the fourth embodiment, the decorative element is a combination of two or more of the flock, woven textile, knitted textile, and metalized film having at least two of the two or more of the flock, woven textile, knitted textile, and metalized film are arranged side by side.

In some configurations of the fourth embodiment, the decorative element is a combination of two or more of the flock, woven textile, knitted textile, and metalized film having at least two of the two or more of the flock, woven textile, knitted textile, and metalized film are arranged one on top of the another.

In some configurations of the fourth embodiment, the first adhesive is positioned between the decorative element and the support layer and the first adhesive is one of a thermoplastic or thermosetting adhesive.

In some configurations of the fourth embodiment, the second adhesive is one of a thermoplastic or thermosetting adhesive.

In some configurations of the fourth embodiment, the flock is sublimation dyed.

In some configurations of the fourth embodiment, the woven textile is sublimation dyed.

In some configurations of the fourth embodiment, the knitted textile is sublimation dyed.

In some configurations of the fourth embodiment, the metalized film is polyurethane.

In some configurations of the fourth embodiment, the metalized film is engraved.

It can be appreciated that one or more of the configurations of the fourth embodiment can be combined in any manner or order.

In some accordance with a fifth embodiment is a method having the steps of providing a decorative element, providing a support element, adhering the decorative element to the support element with a first adhesive, providing a substrate having a surface disruption; and adhering the decorative element to a substrate by a second adhesive.

In some configurations of the fifth embodiment, the first adhesive is provided separately or with one of the decorative element or the support element.

In some configurations of the fifth embodiment, the substrate has a surface disruption, wherein the is provided separately or with the support element.

In some configurations of the fifth embodiment, the support element has a support element areal extent and the second adhesive is in contact with all of the support element areal extent.

In some configurations of the fifth embodiment, the second adhesive is in contact with surface disruption and wherein the surface disruption is not imaged within the decorative element.

In some configurations of the fifth embodiment, one or both of the adhering the decorative element to the support element with a first adhesive and the adhering the decorative element to a substrate by a second adhesive further includes applying one or both of heat and pressure the adhering step.

In some configurations of the fifth embodiment, the substrate is an item of apparel.

In accordance with some configurations of the fifth embodiment, the substrate is a garment.

In some configurations of the fifth embodiment, the substrate is a consumer product.

In some configurations of the fifth embodiment, the substrate is an item of apparel and the surface disruption is a seam.

In some configurations of the fifth embodiment, the surface disruption does not telegraph through to the decorative element.

In some configurations of the fifth embodiment, the surface disruption is not imaged within the decorative element.

In some configurations of the fifth embodiment, the surface disruption is not imaged within the decorative element and is not perceived by a viewer of the decorative element when the carrier sheet is removed from the transfer.

In some configurations of the fifth embodiment, the support layer is a polymeric material.

In some configurations of the fifth embodiment, the support layer is polycarbonate.

In some configurations of the fifth embodiment, the decorative element is flock.

In some configurations of the fifth embodiment, the decorative element is a woven textile.

In some configurations of the fifth embodiment, the decorative element is a knitted textile.

In some configurations of the fifth embodiment, the decorative element is a metalized film.

In some configurations of the fifth embodiment, the decorative element is a combination of two of the flock, woven textile, knitted textile, and metalized film.

In some configurations of the fifth embodiment, the decorative element is a combination of two of the flock, woven textile, knitted textile, and metalized film having the two of the flock, woven textile, knitted textile, and metalized film are arranged side by side.

In some configurations of the fifth embodiment, the decorative element is a combination of two of the flock, a woven textile, a knitted textile, and a metalized film having the two of the flock, woven textile, knitted textile, and metalized film are arranged one on top of the another.

In some configurations of the fifth embodiment, the decorative element is a combination of two or more of the flock, woven textile, knitted textile, and metalized film.

In some configurations of the fifth embodiment, the decorative element is a combination of two or more of the flock, woven textile, knitted textile, and metalized film having at least two of the two or more of the flock, woven textile, knitted textile, and metalized film are arranged side by side.

In some configurations of the fifth embodiment, the decorative element is a combination of two or more of the flock, woven textile, knitted textile, and metalized film having at least two of the two or more of the flock, woven textile, knitted textile, and metalized film are arranged one on top of the another.

In some configurations of the fifth embodiment, the first adhesive is positioned between the decorative element and the support layer and the first adhesive is one of a thermoplastic or thermosetting adhesive.

In some configurations of the fifth embodiment, the second adhesive is one of a thermoplastic or thermosetting adhesive.

In some configurations of the fifth embodiment, the flock is sublimation dyed.

In some configurations of the fifth embodiment, the woven textile is sublimation dyed.

In some configurations of the fifth embodiment, the knitted textile is sublimation dyed.

In some configurations of the fifth embodiment, the metalized film is polyurethane.

In some configurations of the fifth embodiment, the metalized film is engraved.

It can be appreciated that one or more of the configurations of the fifth embodiment can be combined in any manner or order.

These and other advantages will be apparent from the disclosure of the aspects, embodiments, and configurations contained herein.

The decorative element, in accordance with the first through fifth embodiments, includes one or more of flock, woven, knit, and metallized materials arranged in any one of a number of combinations and configurations, that can have a high degree of aesthetic appeal and be useful for an endless variety of applications, including as badges, logos, emblems, trade or brand names, appliqués, heat transfers, patches, stickers, and so on. In one example, a flock base material is combined with one or more sublimation dye printed woven and/or knit textile material(s) configured as insert(s) to the base material. In another example, a flock base material is combined with a metallized material configured as an insert to the base material. In yet another example, a textile or woven base material is combined with one or more flock, woven, knit, and/or metallized material(s) configured as an insert to the base material. In yet a further example, a metallized base material is combined with one or more flock, woven, knit, and/or metallized material(s) configured as insert(s) to the base material. It can be appreciated that the decorative element can be one of a flock, woven, knit, and metallized material. A nearly endless variety of other design combinations is possible.

A decorative element, in accordance with the first through fifth embodiments, need not be a textile at all but can be a decorative material, such as the metallized or non-metallized material, such as an elastomeric or non-elastomeric, cast or extruded polymeric film (e.g., a polyurethane, which may or may not be pigmented to render a desired color and/or texture). The non-textile decorative material can be smooth where an appearance of smoothness is desired. It can have coarse texture (like the embossing on an alligator skin pattern) that cannot be done with a textile. It can create a metallic or holographic or other effect. For example, flock material is typically used to provide not only visual effects but also a soft touch, knit and woven materials for precision graphics plus textile surface patterns and yarn type/characteristics, and a metallized material to provide an intricate molded, finely embossed film-forming which are or can be made to resemble metals. In one application, the decorative element is an elastomeric or non-elastomeric multi-layered film having top and bottom substantially clear or optically transparent adhesive layers sandwiching a pigmented, or colored, polymer layer. In another application, the decorative element is an elastomeric or non-elastomeric, radio frequency moldable, multi-layered construction having an adhesive (lower) layer adhered to a pigmented, or colored, polymer (upper) layer. The decorative element can have a series of holes containing metallic particles or other media (e.g., holograms, lenticular, etc.). Radio frequency molding techniques can be used to impart a desired surface texture and/or design to the upper surface of the decorative element. The decorative element can adhere to a base material or substrate depending on the construction of the decorative article. The decorative element should be heat resistant enough (e.g., have sufficiently high melting and softening points) to be substantially unaffected by the thermal history of the decorative element during decorative article manufacture and application to a substrate.

The division of a design, particularly a graphics design, into discrete decorative elements can provide a way to create additional design dimension and a higher perceived value of the decorative element to a viewer. The design to be dimensionalized can be interpreted, or subdivided, manually or with the aid of a computer, into separate different discrete decorative elements with the purpose of reassembling the discrete decorative elements with material types to create a perception of dimensionality. As noted, each discrete decorative element can be a separate physical layer of material and/or decoration of that layer (e.g., insert). As noted, each layer can be made of different materials treated (e.g., printed, embossed, etc.) in different ways so as to create the desired internal contrast or interplay of the discrete decorative elements.

The discrete decorative elements can be constructed in a variety of ways to form the decorative element. The insert and base materials can be combined in a side-by-side arrangement. The side-by-side arrangement can be effected using a window, aperture or other discontinuity in the base or insert material, void or other discontinuity in the base or insert material, or other discontinuity formed in the base or insert material to receive the insert material and/or reveal the base material to the viewer. The side-by-side arrangement can alternatively or additionally be effected using an adhesive-coated tie material, or common support material, to support simultaneously all of the decorative elements. The tie material can be substantially clear, substantially opaque, color matched or contrasted to an overlying material, or a combination thereof. The various discrete decorative elements are placed, in correct registered position, on the adhesive (which, for example, can be a pressure sensitive or hot melt adhesive). The insert and base material can be combined in a stacked arrangement in which the insert material is positioned on top of the base material. Stated another way, the insert material is positioned in some but not other areas of the underlying base material to reveal the base material adjacent to the insert material.

Generally, the adhesives used to hold together the various discrete decorative elements of the decorative article have higher melting and softening points than the underlying adhesive used to adhere the decorative element to a substrate. The discrete decorative elements can be pre-colored, dyed, or sublimation dye printed. Heat, pressure, and/or dwell time applied during sublimation dye heat transfer printing can also cause unacceptable adhesive migration through the decorative element(s). To avoid or other discontinuity this result, the adhesive(s), particularly adhesives having a melting and/or softening point lower than the thermal history during sublimation dye heat transfer printing, are applied after the printing step.

A release adhesive-coated transfer film, which is preferably substantially clear to permit proper placement on the substrate, can be used to hold discrete decorative elements or hybrid articles in registered position for application to a substrate, such as a textile. For example, the letters in a word or logo, brand name, or other design, can be maintained in discrete, registered positions for simultaneous application, such as by heat transfer, to a substrate. Registration marks on the transfer film can be used to position properly the various decorative elements and/or articles.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

“Adhesive” generally refers to a composition comprising homopolymers, copolymers or polymer alloy comprising one or more of polyolefins, polystyrenes, polyvinyls, polyacrylics, polyhalo-olefins, polydienes, polyoxides, polyesthers, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, and combinations and/or mixtures thereof. More specifically in a preferred embodiment, the thermoplastic adhesive composition comprises one of acrylonitrile butadiene styrene, acrylic (PMMA), celluloid, cellulose acetate, cyclo-olefin copolymer, ethylene-vinyl acetate (EVA), ethylene vinyl alcohol (EVOH), fluoroplastic (PTFE, FEP, PFA, CTFE, ECTFE, and/or ETFE), ionomer, liquid crystal polymer (LCP), polyacetal (POM and/or acetal), polyacrylate (acrylic), polyacrylonitrile (PAN or acrylonitrile), polyamide (PA or nylon), polyamide-imide (PAI), polyaryletherketone (PAEK and/or ketone), polybutadiene (PBD), polybutylene (PB), polybutylene teraphthalate (PBT), polycaprolactone (PCL), polychlorotrifluoroethylene (PCTFE), polyethylene terephthalate (PET), polycycloheylene dimethylene terephthalate (PCT), polycarbonate (PC), polyhydroxyalkanoate (PHA), polyketone (PK), polyester, polyethylene(PE), polyetherketoneketone (PEKK), polyetherimide (PEI), polyethersulfone (PES), polysulfone, polyethlenechloriate (PEC), polyimide, polyacetic acid (PLA), polymethylpentene (PMP), polyphenylene oxide (PPO), polyphylene sulfide (PPS), polyphthalamide (PPA), polypropylen (PP), polystyrene (PS), polysulfone (PSU), polytrimethylen teraphthalate (PTT), polyurethane (PU), polyvinyl acetate (PVA), polyvinyl chloride (PVC), polyvinylidene chloride (PVDC), styrene-acrylonitrile (SAN), and combinations thereof. The adhesive may be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differing in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties, and the polymeric film may comprise one or more of an elastomeric material, a substantially inelastic material, clear, opaque, colored, uncolored, or a combination thereof. The polymeric film may be a tie layer.

“Carrier sheet” or “transfer sheet” generally refers to any material that is dimensionally stable under the conditions of temperature and pressure encountered during any of the processing conditions presented herein. Typically, but not always, the carrier sheet is a discontinuous as opposed to a continuous sheet on a running web line. The carrier sheet may be any low-cost, dimensionally stable article to be decorated, such as paper, plastic film, and the like, typically in the form of a discontinuous sheet or a running web line material.

“Elastomeric polymeric materials,” “elastomeric polymers,” and “elastomeric materials” generally refer to one or more of rubbers, polyisoprenes, polybutadienes, styrene-butadienes, chloroprenes, ethylene propylene rubbers, ethylene-vinyl acetates, ethylene propylene diene rubbers, polyacrylic rubbers, epichlorohydrin rubbers, fluorosilicones, fluoroelasters, silicones, perfluoroelastomers, polyether block amides, chlorosulfonated polyethylenes and combinations thereof). Non-limiting examples of stretchable and elastic-knits/stretchable and elastic-weaves are sprang waves, mesh-weaves, open weaves, warp knits, and two-way knits. While not wanting to be limited by example, suitable stretchable and elastic-knits/stretchable and elastic-weave textile materials are Lycra™, Spandex™, 4-, 3-, 2-, or 1-way stretch fleece fabrics, and stretch cotton weaves (such as, stretch rayon jersey knit and/or cotton/Lycra™ combinations).

“Knit” generally refers to a fabric having a series of connected loops. The loops are generally made by intertwining yarn, thread, or strips in a series of consecutive loops, called stitches. As each row progresses, a new loop is pulled through an existing loop. The loops are generally easily stretched in different directions. Knitting normally uses one set of yarn, which is worked either horizontally or vertically, not both. Knitting typically has two recognized knitting structures, namely warp and weft knitting. Warp knitting has one set of yarn for each wale, each yarn travelling vertically. Weft knitting has one set of yarn, which travels horizontally across the fabric. The knitted textile can be formed by any knitting process, including but not limited to weft knitting (in which the wales are substantially perpendicular to the course of the yarn), warp knitting (in which the wales and courses are roughly parallel to each other), knit stitch, purl stitch, stockinette, reverse stockinette, garter stitch, seed stitch, right-plaited stitches, left-plaited stitches, flat knitting, circular knitting, a single yarn knit, a plurality of yarns knit, a double knit textile, an uneven knit, a shadow knit, a fair-isle knit, a plaited knit, flat knitting, circular knitting, or felt knitting. Examples of possible knit patterns or constructions include knits and purls, reversible stitch patterns, eyelets and lace, mosaic stitch patterns, multi-color stitch patterns, and the like. Specific examples of patterns include basketweave, basketweave II, box stitch, broken rib, cable stitch, casting on, casting off, checks and ridges, chevron, close checks, decrease, diagonal rib, diagonals, diamond pattern, double basket weave, double seed stitch, elongated chevron, embossed diamonds, embossed moss rib, garter rib, garter stitch, garter stitch steps, increase, Inverness diamonds, King Charles brocade, knit stitch, large diamonds, little pyramids, mistake rib, mock cable, moss diamonds, moss panels, moss stitch, moss stitch border diamonds, moss stitch parallelograms, parallelograms, parallelograms II, pavilion, pique triangles, plain diamonds, purl stitch, purled ladder, rib stitch, rice stitch, seed stitch, single chevron, slip stitch, spaced checks, squares, squares in squares, stocking stitch, thermal underwear stitch, triangles, triangle ribs, triangle squares, triangles, twin rib, two by two rib, windmill, woven stitch, yarn over, and combinations thereof. A preferred decorative element has knit and purl stitches arranged substantially symmetrically (such as in ribbing, garter stitch, or seed stitch) so that the decorative element lies substantially flat.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

A “metalized material” or “metalized film” generally refers to one or more of a polymeric composition-containing metallized particles, a polymeric composition having a metallized coating, a polymeric composition having a metallized appearance, a metal-containing composition, and a combination and/or mixture thereof. The metallized material may comprise a molded polyurethane or silicone. Typically, the metallized material comprises molded polyurethane formed by high-frequency molding and/or shaping processes. More typically, the metallized material comprises molded metal-containing polyurethane formed by high-frequency molding and/or shaping processes. The high frequency molding process is commonly a radio frequency molding process. The molded polyurethane may have a single metallic hue. The metal may be any metal. Generally, the metal is silver, nickel, aluminum, or alloys and combinations thereof. The metal may be encapsulated and/or dispersed in the polymeric material. The metal may be coated to provide for additional and/or different hues. For example, the metal can be coated with yellow hue to provide for a gold look, or dark orange for copper look. Commonly, the metal may be encapsulated and/or dispersed in the polyurethane. While not wanting to be limited by example, the metal may be encapsulated and/or dispersed between two polymeric film layers. The metallized material may or may not include an adhesive layer. The metallized material typically has a metallic surface or metallic-like appearing surface and an opposing surface. The opposing surface may or may not include the adhesive layer. The adhesive layer can be in the form of an adhesive film layer. The metallic-appearing surface is commonly in the form of three-dimensional surface. The three-dimensional surface is formed during the high frequency molding process. Furthermore, edges of the metallized material can formed during the molding process. That is, the edges may be formed using a combination of high frequency energy and/or heat. Furthermore, the edges may be formed during the molding process by the mold die, specifically by the edge of the mold die and the pressure applied during the molding process. The molding process may or may not include welding a textile base to metallized material. Commonly, the metallized material is provided without a textile base. However, when provided with a textile base, the textile base is part of the metallized material. That is, the textile base of the metallized material is not a decorative element as used herein, other than that of the metallized material the textile base is molded thereto. The high frequency molding cannot cut through flock fibers, such as nylon flock fibers, nor through typical textile materials such as polyester-containing textile materials. More specifically, the high frequency molding process cannot cut through polymeric materials having a melting point greater than nylon and/or polyester. Even more specifically, the textile base has a melt temperature no more than about 190 degrees Celsius, commonly no more than about 180 degrees Celsius, even more commonly no more than about 170 degrees Celsius. The metallized material can be one or more of pliable, soft and washable. More specifically, the metallized material can be laundered with clothing. The metallized material can be fabricated to resemble a metallic badge, such as, a police officer's badge, a fire department badge, a federal agent's badge or such.

“Polymer” or “polymer composition generally refers to a molecule comprising a plurality of repeating chemical groups, typically referred to as monomers. Polymers include man-made polymers, natural polymers and mixtures thereof. Polymers are often characterized by high molecular masses. Useful polymers include organic polymers and inorganic polymers both of which may be in amorphous, semi amorphous, crystalline, partially crystalline states, or combinations thereof. Polymers may comprise monomers having the same chemical composition or may comprise a plurality of monomers having different chemical compositions, such as a copolymer. Cross-linked polymers have linked monomer chains. Useful polymers include but are not limited to plastics, elastomers, thermoplastic elastomers, elastoplastics, thermosets, thermoplastics and acrylates. Exemplary polymers include but are not limited to acetal polymers, biodegradable polymers, cellulosic polymers, epoxies, fluoropolymers, polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, nylons, polyacrylonitrile polymers, polyamide, imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate), polymethylpentene, polyphenylene oxides and polyphenylene sulfides, polyphthalamide, polypropylene, polyvinyls, polyurethanes, natural and synthetic rubber, silicones, styrenic resins, sulfone based resins, vinyl based resins and any combinations of these.

“Release adhesive” generally refers to any adhesive that adheres more strongly to the carrier or transfer sheet than the appliqué but adheres to both enough to hold them together. For example, the release adhesive may be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients. Commonly, the release adhesive is a water-based adhesive; that is, the release adhesive is one or more of dispersed, dissolved, suspended or emulsified within water.

A “satin” weave and/or satin textile material generally refers to a flat, smoothly woven type weave, such as, but not limited to satin type weaves with an interlacing float of at least 2 or to at least the following satin weave types commonly known within the art as:

a) Brocade—A brocade weave is a compound weave where a supplementary warp or filling yarn is inlaid into a base fabric to produce an embroidered appearance. (The supplementary or filling yarn is a yarn that can be removed without affecting the base fabric.) Brocade weaves can be continuous where the supplementary yarn floats on the back of the base fabric and is not visible on the fabric face, or discontinuous where the supplementary yarn is woven into the patterned areas visible on the fabric face.

b) Brocatelle—A brocatelle weave is a highly textured or high-relief motif produced with an additional yarn the runs between the fabric face and back to produce a pronounced texture, or dimensionality, or relief to the fabric surface. Brocatelle weaves are typically based on, but not limited to, satin weaves.

c) Camocas—A comocas fabric is typically a stain weave with a diapered design.

d) Crepe-back satin, Satin-back crepe, Crepe-satin, or Satin-crepe—These fabrics typically comprise a stain weave on the fabric face and a crepe crinkled affect produced by the weave, yarn or finishing technique on the back of the fabric. Typically weft crepe yarns are twisted and outnumber any supplemental or filling yarn by a factor of at least 2:1.

e) Duchesse—A duchesse weave is a high thread count satin weave, typically woven with fine yarns having a higher density of warp to weft yarns. Duchesse fabrics have a high luster and are highly textured and firm.

f) Satin—A warped-faced satin weave satin weave is a weave where warp yarns pass over multiple weft yarns before interlacing another waft yarn, or filling-faced satin weave where weft yarns pass over multiple warp yarns before interlacing another warp yarn. A satin weave produces a fabric surface where the warp and weft intersection points are as widely spaced as possible. Satins are typically woven with low twist filament yarns.

g) Double-face satin—A double-face satin has two satin constructions, one on the face and another on the back, produced by a weave having two warps and one weft.

h) Paillette satin—A paillette stain is a weave that produces a changeable color affect.

i) Peau de soie—A peau de soie stain weave can be of a single or double construction, typically characterized by a cross-rib texture in the weft direction and a slight luster.

j) Satin-back—A satin-back fabric is characterized by a weave and/or fabric on one side and any other weave or fabric on the opposing fabric side.

k) Satin foaconne—A stain foaconne is a slightly creped fabric with small designs.

l) Slipper satin—A slipper satin is a compact satin that can be brocaded.

m) Velvet satin—A velvet satin comprises a warp-pile satin weave with a short, dense cut pile. The pile consists of a looped yarn on the fabric surface; the loop can be produced by: 1) knotting the yarn at the base of the fabric; 2) weaving the yarn over wires to produce loops at the base of the fabric and cutting the loops to produce a cut pile; or 3) weaving the warp yarn to produce a double cloth and slicing the warp yarns positioned between the two opposing cloth surfaces to produce two cut-pile fabrics.

“Substrate” generally refers to any article to be decorated. The substrate may comprise any material. Non-limiting examples of suitable substrates comprise metallic materials, synthetic or natural polymeric materials, glass-based materials, ceramic materials, leather-based materials and combinations thereof and may or may not be stretchable and/or have elastic properties. The substrate may comprise an item of apparel, typically a stretchable, elastic, and/or bendable item of apparel. Non-limiting examples of stretchable and elastic items of apparel are jerseys, leotards, pants, shirts, blouses, leggings, socks, shoes, under garments, and accessories (such as, but not limited to, hair-bands, wrist bands, head bands, finger bands, ankle bands, finger bands, toe-bands, arm bands, and shoe-laces). The substrate may have a single surface or a plurality of surfaces. Non-limiting examples of a single-surfaced substrate are articles having one of a generally spherical, circular-donut, and elliptical-donut shapes. Non-limiting examples of substrates having a plurality of article surfaces are articles substantially resembling one of a cube, rectangular-box and tetrahedral shapes. The substrate can include one of the hook or loop component of hook and loop attachment system.

“Textile material” generally refers to one of: a woven textile material; a knitted textile material; a non-woven, non-knitted textile material; a substantially elastomeric textile material; a substantially non-elastomeric textile material; and a combination and/or mixture thereof. The textile material can be a suede-like fabric. Moreover, the textile material can be a microfiber textile material.

“Woven” generally refers to a fabric comprising at least two sets of yarn, thread, or strips, one warp (longitudinal) and one filling yarn, thread, or strip (transverse or crosswise), normally laced at substantially right angles to each other. Commonly, the yarn, thread, or strips are straight, run parallel either lengthwise (warp threads) or crosswise (weft threads). The weft yarn is commonly interlocked with the warp by passing under then over, one or more warp threads. Elasticity can be increased in woven fabrics when they are woven from yarn containing elastomeric yarn such as elastane (Lycra® from Invista or Dorlastan® from Bayer).

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A depicts a cross-section view of substrate the having a surface disruption extending above the substrate surface in accordance to some embodiments of the present disclosure;

FIG. 1B depicts a cross-section view of substrate having a surface disruption extending below the substrate surface in accordance to some embodiments of the present disclosure;

FIG. 2 depicts a cross-sectional view of an appliqué according to some embodiments of the present disclosure;

FIG. 3 is a planar view of the support layer of FIGS. 2, 5A, 5B, 6, 7A and 7B according to some embodiments of the present disclosure;

FIG. 4 is a planar view of the second adhesive areal extent according to some embodiments of FIGS. 2, 5A, 5B, 6, 7A and 7B of the present disclosure;

FIGS. 5A and 5B depict cross-sectional views of decorative articles according to some embodiments of the present disclosure;

FIG. 6 depicts a transfer according to some embodiments of the present disclosure;

FIGS. 7A and 7B depict an article of manufacture according to some embodiments of the present disclosure;

FIG. 8 is photograph of an article lacking a support layer adhered to a substrate having a surface disruption;

FIG. 9 is photograph of article of FIG. 8 with a support layer in accordance with the present disclosure adhered to a substrate having a surface disruption; and

FIG. 10 depicts a process according to various embodiments of the present disclosure.

### DETAILED DESCRIPTION

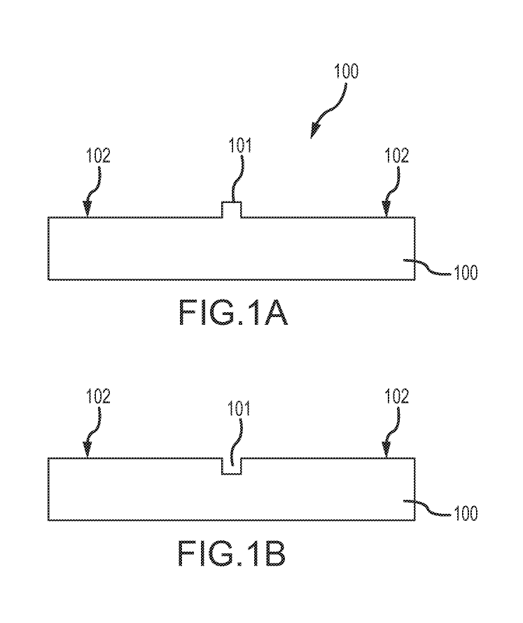

FIGS. 1A and 1B depict a substrate 100 having a surface disruption 101. The surface disruption 101 can extend above substrate surface 102, as depicted in FIG. 1A, or below the substrate surface 102, as depicted in FIG. 1B. The substrate 100 can be any material. Typically, the substrate 100 comprises one of a metallic material, a synthetic polymeric material, a natural polymeric material, a glass-based material, a ceramic material, a leather-based material or a combination thereof. The substrate 100 may or may not be stretchable and/or have elastic properties. The substrate 100 may comprise an item of apparel. Non-limiting examples of items of apparel are jerseys, leotards, pants, shirts, blouses, leggings, socks, shoes, under garments, and accessories (such as, but not limited to, hair-bands, wrist bands, head bands, finger bands, ankle bands, finger bands, toe-bands, arm bands, and shoe-laces). The substrate may have a single surface or a plurality of surfaces. The surface disruption 101 is commonly a seam, fold, joint, undulation within the substrate surface 102 or a combination thereof.

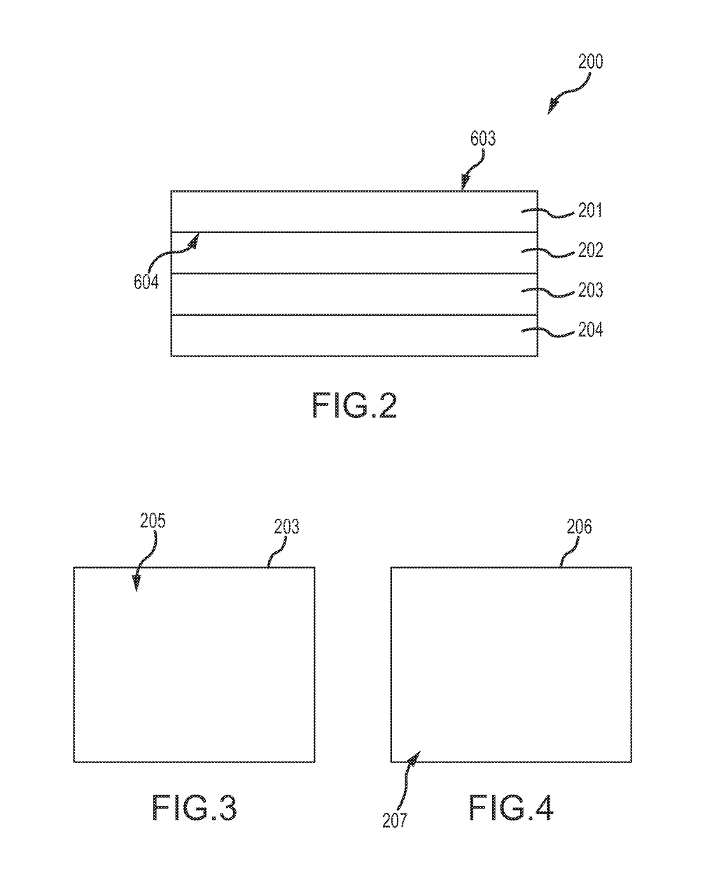

FIG. 2 depicts an appliqué article 200 having support layer 203 positioned between first 202 and second 204 adhesives and a decorative element 201 adhered to the first adhesive 202.

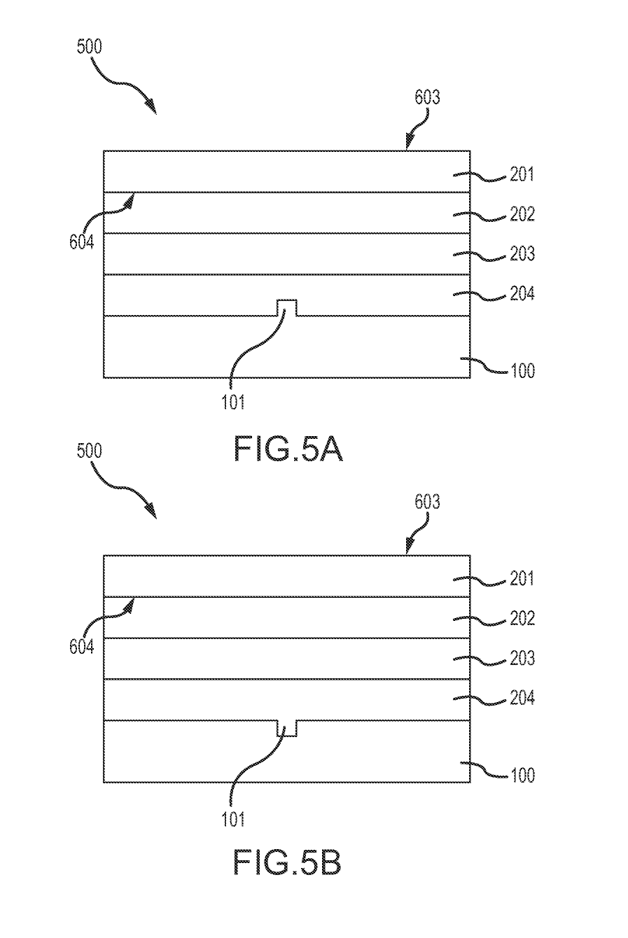

FIGS. 5A and 5B depict decorative articles 500 comprising a decorative element 201, a support layer 203 positioned between first 202 and second 204 adhesives, and a substrate having 100 a surface disruption 101. The second adhesive 204 is positioned between the substrate 100 and the support layer 203 and is in contact with the surface disruption 101. The first adhesive 202 is positioned between the decorative element 201 and the support layer 203.

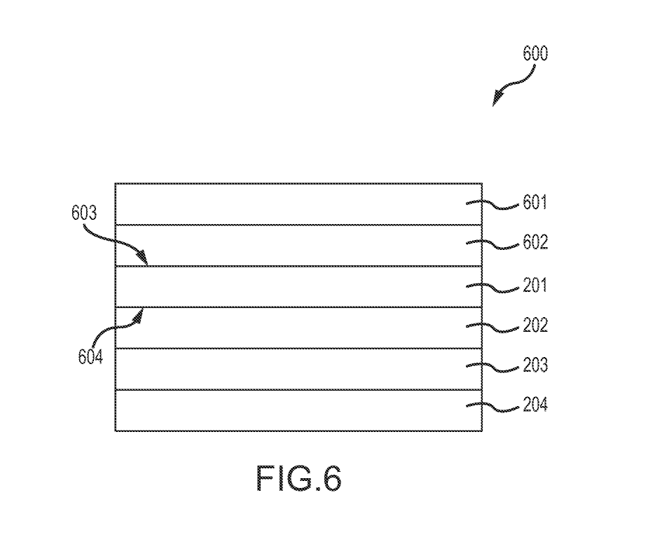

FIG. 6 depicts a transfer 600 comprising a decorative element 201, a release adhesive 602 positioned between a carrier sheet 601 and a first surface 603 of the decorative element 201, a support layer 203 positioned between first 202 and second 204 adhesives, and a second surface 604 of the decorative element 201 adhered to the first adhesive 202. The first 603 and second 604 surfaces of the decorative element 202 are in an opposing relationship.

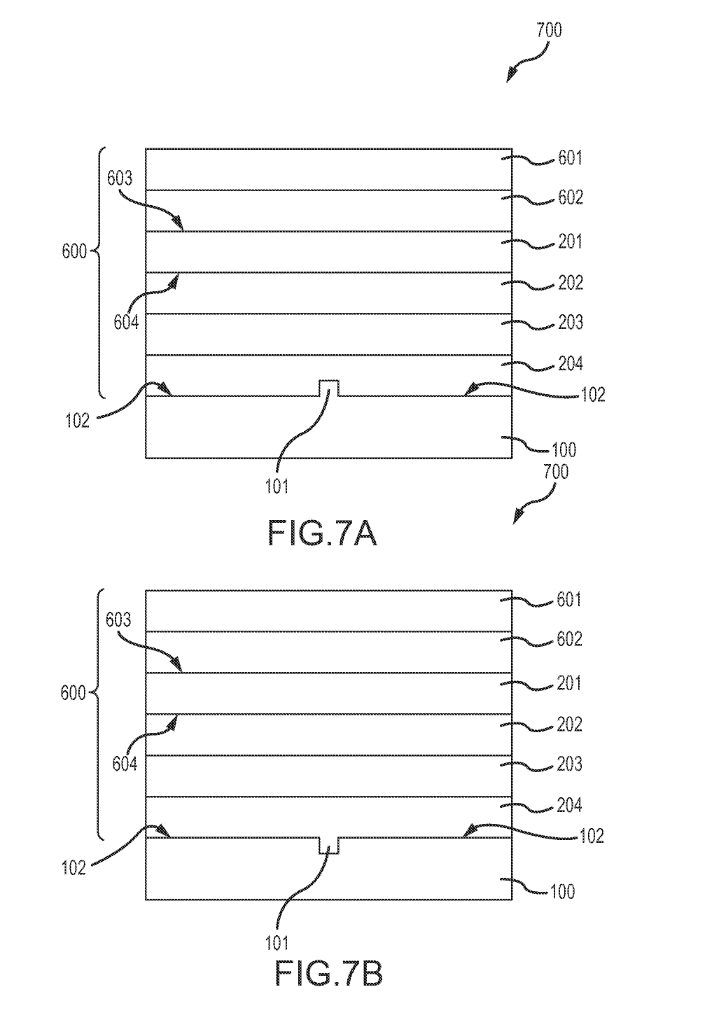

FIGS. 7A and 7B depict an article of manufacture 700 comprising the transfer 600 (FIG. 6) adhered to the substrate 100 having a disruption 101 (FIGS. 1A and 1B). The surface disruption 101 can extend above substrate surface 102, as depicted in FIG. 1A, or below the substrate surface 102, as depicted in FIG. 1B. The transfer 600 is adhered to the substrate 100 by the second adhesive 204. The second adhesive 204 is positioned between the substrate 100 and the support layer 203 and is in contact with the surface disruption 101. The first adhesive 202 is positioned between the decorative element 201 and the support layer 203.

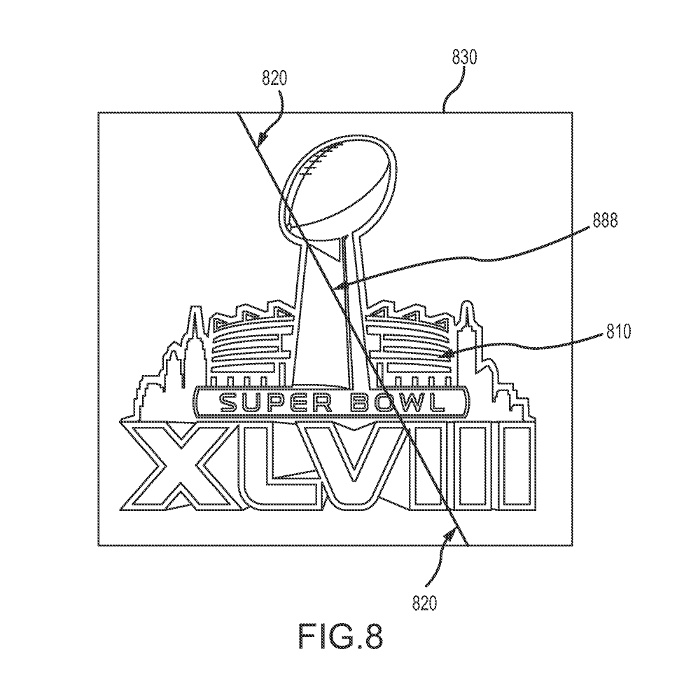

FIG. 8 depicts an appliqué 810 adhered about a seam 820 of a garment 830 with a support layer of the present disclosure positioned between the garment 830 and the visible surface of the appliqué 810. As such, an image of the seam 888 is visible to a view of the appliqué surface.

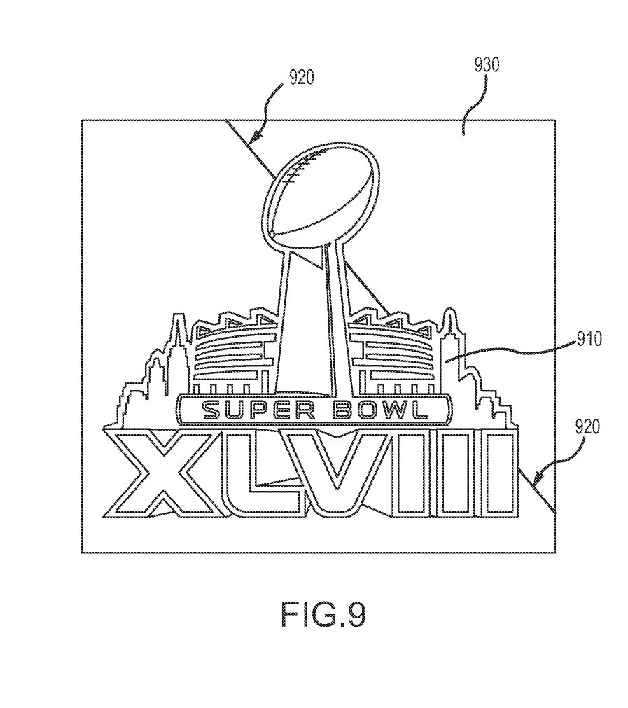

FIG. 9 depicts an appliqué 910 adhered to a seam 920 of a garment 930. The appliqué 910 has a support element (not visible within the photograph) position between the visible surface of appliqué 910 and garment 930. The support element substantially blocks and/or inhibits the telegraphing of the seam 920 through appliqué 910. As such, an image of the seam 920 is not visible to a view of the appliqué surface.

The decorative element 201 (FIGS. 2, 5A, 5B, 6, 7A and 7B) can be selected from the group consisting of flock, a woven textile, a knitted textile, a metalized film, or a combination thereof.

In some configurations, the decorative element 201 (FIGS. 2, 5A, 5B, 6, 7A and 7B) comprises flock. In some configurations the decorative element 201 is flock. The flock can be sublimation dyed.

In some configurations, the decorative element 201 (FIGS. 2, 5A, 5B, 6, 7A and 7B) comprises a woven textile. In some configurations the decorative element 201 is a woven textile. The woven textile can be sublimation dyed. Moreover, the woven textile may contain a sublimation dyed graphic image.

In some configurations, the decorative element 201 (FIGS. 2, 5A, 5B, 6, 7A and 7B) comprises a knitted textile. In some configurations the decorative element 201 is a knitted textile. The knitted textile can be sublimation dyed. Moreover, the knitted textile may contain a sublimation dyed graphic image.

In some configurations, the decorative element 201 (FIGS. 2, 5A, 5B, 6, 7A and 7B) comprises a metalized film. In some configurations the decorative element 201 is a metalized film. The metalized film can comprise polyurethane. Moreover, the metalized film may be engraved.

In some configurations, the decorative element 201 (FIGS. 2, 5A, 5B, 6, 7A and 7B) comprises a combination of two or more elements elected from the group consisting of flock, a woven textile, a knitted textile, and a metalized film. The combination of the two or more elements can be arranged side by side, one on top of the another or a combination of side by side and one on top of the another. Frequently, the combination of the two or more elements are arranged in a combination of side by side and one on top of the another, more frequently the combination of the two or more elements are arranged side by side, or even more frequently the combination of the two or more elements are arranged one on top of the another.

In some configurations, the decorative element 201 (FIGS. 2, 5A, 5B, 6, 7A and 7B) comprises two elements elected from the group consisting of flock, a woven textile, a knitted textile, and a metalized film. The combination of the two can be arranged side by side or one on top of the another. Frequently, the combination of the two elements is a side-by-side arrangement. More frequently the combination of the two elements is a one on top of the another arrangement. In some configurations some of the elements can be arranged side by side and other elements, in one or more of some of the elements arranged side-by side, can be arranged one on top of the other.

The support layer 203 (FIGS. 2, 5A, 5B, 6, 7A and 7B) has a support layer areal extent 205 (FIG. 3). The second adhesive 204 (FIGS. 2, 5A, 5B, 6, 7A and 7B) is in the form of a first adhesive layer 206 having a second adhesive areal extent 207 (FIG. 4). The support layer areal extent 205 and the second adhesive areal extent 207 are substantially equal.

Commonly, the support layer 203 (FIGS. 2, 5A, 5B, 6, 7A and 7B) has a tensile strength from about 25 to about 115 MPa, more commonly from about 35 MPa to about 95 MPa, even more commonly form about 45 to about 85 MPa, or yet even more commonly from about 55 to about 75 MPa.

Typically, the support layer 203 (FIGS. 2, 5A, 5B, 6, 7A and 7B) has a tensile modulus from about 1,300 to about 3,000 MPa, more typically from about 1,700 to about 2,700 MPa, even more typically from about 1,900 to about 2,500 MPa, or yet even more typically from about 1,800 to about 2,400 MPa.

Generally, the support layer 203 (FIGS. 2, 5A, 5B, 6, 7A and 7B) has a thickness from about 0.05 to about 1.5 mm, more generally from about 0.08 to about 1.2 mm, even more generally from about 0.1 to about 1.0 mm, and yet even more generally from 0.1 to 0.8 mm,

Frequently, the support layer 203 (FIGS. 2, 5A, 5B, 6, 7A and 7B) has a softening temperature greater than about 120 degrees Celsius, more frequently a softening temperature greater than about 130 degrees Celsius, even more frequently a softening temperature greater than about 140 degrees Celsius, yet even more frequently a softening temperature greater than about 145 degrees Celsius, still yet even more frequently a softening temperature greater than about 150 degrees Celsius, still yet even more frequently a softening temperature greater than about 160 degrees Celsius, still yet even more frequently a softening temperature greater than about 170 degrees Celsius, or yet still even more frequently a softening temperature greater than about 180 degrees Celsius,

It can be appreciated that the support layer 203 (FIGS. 2, 5A, 5B, 6, 7A and 7B) can have any of combination of one or more of the above tensile strengths, tensile moduli, thicknesses, and softening temperatures.

The support layer 203 (FIGS. 2, 5A, 5B, 6, 7A and 7B) can comprise any material. The support layer 203 can comprise a polymeric material. The polymeric material can be a plastic, elastomer, thermoplastic elastomer, elastoplastic, thermoset, thermoplastic and acrylate. Exemplary polymeric materials include, but are not limited to, acetal polymers, biodegradable polymers, cellulosic polymers, epoxies, fluoropolymers, polyolefins, polystyrenes, polyvinyls, polyacrylics, polyhalo-olefins, polydienes, polyoxides/esthers/acetals, polysulfides, polyesters/thioesters, polyamides/thioamides, polyurethanes/thiourethanes, polyureas/thioureas, polyimides/thioimides, polyanhydrides/thianhydrides, polycarbonates/thiocarbonates, polyimines, polysiloxanes/silanes, polyphosphazenes, polyketones/thioketones, polysulfones/sulfoxides/sulfonates/sulfoamides, polyphylenes, nylons, polyacrylonitrile polymers, polyamide, imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate), polymethylpentene, polyphenylene oxides and polyphenylene sulfides, polyphthalamide, polypropylene, polyvinyls, polyurethanes, natural and synthetic rubber, silicones, styrenic resins, sulfone based resins, vinyl based resins and any combinations of these.

In some configurations, the support layer 203 (FIGS. 2, 5A, 5B, 6, 7A and 7B) comprises a polycarbonate.

The first adhesive 202 (FIGS. 2, 5A, 5B, 6, 7A and 7B) positioned between the decorative element 201 and the support layer 203 can comprise a thermoplastic adhesive, a thermosetting adhesive or a combination thereof.

The second adhesive 204 (FIGS. 2, 5A, 5B, 6, 7A and 7B) can comprise a thermoplastic adhesive, a thermosetting adhesive or a combination thereof.

The first 202 and second 204 adhesives may or may not differ. More generally, the first 202 and second 204 adhesives may separately and independently be one of a thermosetting adhesive, a thermoplastic adhesive, a substantially A-staged thermosetting adhesive, a substantially B-staged thermosetting adhesive, a self-supporting adhesive film, a bi-laminate adhesive film having first and second adhesive layers, the first adhesive layer and second adhesive layer differ in one or both of chemical composition and physical properties, a tri-laminate adhesive film having a polymeric film positioned between a first adhesive film and a second adhesive film, a fast flow, low-melt adhesive, a hot-melt adhesive; and a combination and/or mixture thereof. Further regarding the tri-laminate adhesive film, the first adhesive film and second adhesive film may differ in one or both of chemical composition and physical properties, or have substantially the same chemical composition and physical properties and the polymeric film may comprise one or more of an elastomeric material, a substantially inelastic material, clear, opaque, colored, uncolored, or a combination thereof. The polymeric film may be a tie layer.

The appliqué 200 and decorative article 500 can, in some configurations, include a release adhesive 602 positioned between a carrier sheet 601 and the decorative element 201. Moreover, the release adhesive 602 can be positioned between the carrier sheet 601 and a first surface 603 of the decorative element 201. Moreover, a second surface 604 of the decorative element 201 can be adhered to the first adhesive 202. The first 603 and second 604 surfaces of the decorative element 201 are in an opposing relationship.

In some configurations of FIGS. 5A, 5B, 7A and 7B and optional configurations of FIGS. 2 and 6, the substrate 100 (FIGS. 1A and 1B) can be one of an item of apparel, a consumer product or a garment.

Commonly, the substrate 100 is an item of apparel. More commonly, the surface disruption 101 in the item of apparel is a seam.

Typically, the substrate 100 is a garment. More typically, the surface disruption 101 in the garment is a seam.

Generally, the substrate 100 is a consumer product. More generally, the surface disruption 101 in the consumer product is one of a seam, fold, joint, undulation or combination thereof in the consumer product.

With reference to reference to the appliqué 200, decorative article 500, transfer 600 and article of manufacture 700, the surface disruption 101 does not telegraph the support layer 203. The support layer 203 inhibits the imaging and/or replication of surface disruption 101 image within the decorative element 201. Stated another way, the support layer 203 eliminates the reproduction of the surface disruption 101 within the decorative element 201. In some configurations of the appliqué 200, decorative article 500, transfer 600 and article of manufacture 700, the surface disruption 101 is not imaged within the decorative element 201. Furthermore, in some configurations of the appliqué 200, decorative article 500, transfer 600 and article of manufacture 700, the surface disruption 101 is not imaged within the decorative element 201 and is not perceived by a viewer of the decorative element 201. Moreover, in some configurations of the appliqué 200, decorative article 500, transfer 600 and article of manufacture 700, the surface disruption 101 is not imaged within the decorative element 201 and is not perceived by a viewer of the decorative element 201 when the carrier sheet 601 is removed from the appliqué 200, decorative article 500, transfer 600 and article of manufacture 700.

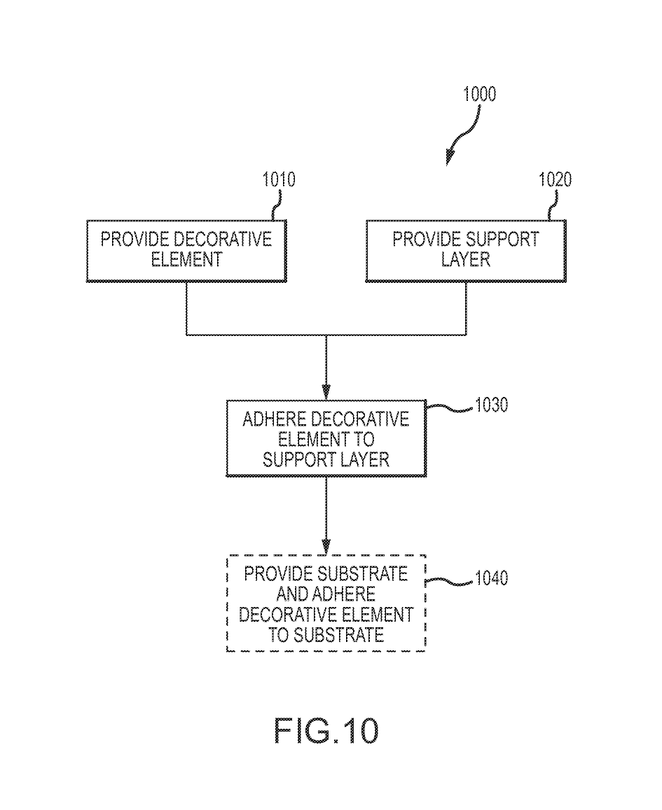

FIG. 10 depicts process 1000 for making one or more of the articles of depicted FIGS. 2, 5A, 5B, 6, 7A and 7B.

In step 1010, the decorative element 201 is provided. The decorative element 201 can be provided with or without a carrier sheet 601 adhered to the decorative element 201 by a release adhesive 602. The carrier sheet 601 can have registration marks. When the decorative element 201 is provided with a release adhesive 602, the release adhesive is adhered to a first surface 603 of the decorative element 201. In some configurations, the decorative element 201 can be provided with or without the first adhesive 202 adhered to the decorative element 201. When the decorative element 201 is provided with the first adhesive 202 is adhered to a second surface 604 of the decorative element 201. The first 603 and second 604 surfaces of the decorative element 201 are in an opposing relationship.

In step 1020, the support layer 203 is provided. In some configurations, the support layer 203 can be free of first 202 and second 204 adhesives. In some configurations, the support layer 203 can be provided with one or both of the first 202 and second 204 adhesives. When the support layer 203 is provided with the first adhesive 202, the first adhesive 202 is adhered to first surface 613 of the support layer 203. When the support layer 203 is provided with the second adhesive 204, the second adhesive 204 is adhered to second surface 614 of the support layer 203. The second adhesive 204 is distributed over the entire areal extent of the second surface 614 of the support layer 203.

The support layer 203 can be provided with or without a carrier sheet 601 adhered to the decorative element 201 by a release adhesive 602. The carrier sheet 601 can have registration marks. When the support layer 203 is provided free of the first 202 and second 204 adhesives, the release adhesive 602 is adhered to the second surface 614 of the support layer 204 and to the carrier sheet 601. When the support layer 203 is provided with the first adhesive 202 adhered, the first adhesive is adhered to the first surface 613 of the support layer 203 and the release adhesive 602 adhered to the second surface 614 of the support layer 204 and to the carrier sheet 601. When the support layer 203 is provided with the first 202 and second 204 adhesives adhered to the support layer 203, the release adhesive 602 is adhered to the second adhesive 204. The second adhesive 204 is distributed over the entire areal extent of the second surface 614 of the support layer 203.

In step 1030, the decorative element 201 is adhered to the support layer 203 by the first adhesive 202. Moreover, step 1030 can include one or both of heat and pressure. The applying of heat and pressure permanently adheres the decorative element 201 to the support layer 203. When one or both of the decorative element 201 and support layer 204 are provided with a carrier sheet 601, step 1030 can included registering the decorative element 201 and support element 203 using the registration marks contained on the carrier sheet 601.

When both the decorative element 201 and the support layer 203 are provided free of the first adhesive 202, the first adhesive 202 is provided in step 1030 and contacted with the decorative element 201 and the support layer 203. The contacting of the first adhesive 202 with the decorative element 201 and support layer 203 can be one of sequentially or one after the other. The sequential or one after the other contacting of first adhesive 202 with the decorative element 201 and support layer 203 can be prior to or concurrently with the adhering of the decorative element 201 to the support layer 203.

When the decorative element 201 is provided with the first adhesive 202, the support layer 203 and the first adhesive 202 are contacted and adhered.

When the support layer 203 is provided with the first adhesive 202, the decorative layer 201 and the first adhesive 202 are contacted and adhered.

In some embodiments, process 1000 can include step 1040, providing substrate 100. In step 1040, the decorative element 201 adhered to the support layer 203 by the first adhesive 202 is adhered to the substrate 100 by second adhesive 204. One or both of heat and pressure can be applied during step 1040. The applying of heat, pressure or both adheres the decorative element 201 and support layer 203 to the substrate 100. The second adhesive 204 is distributed over the entire areal extent 205 of the second surface 614 of the support layer 203. Furthermore, the entire areal extension 270 of the second adhesive is in contact with and adhered to substrate 100.

In some configurations of step 1040, the second adhesive 204 is provided and contacted with the substrate 100 and the support layer 203. The contacting of the second adhesive 204 with the substrate 100 and support layer 203 can be one of sequentially or one after the other. The sequential or one after the other contacting of second adhesive 204 with the substrate 100 and support layer 203 can be prior to or concurrently with the adhering of the decorative element 201 and support layer 203 to the substrate 100.

In some configurations of step 1040, decorative article 500 is formed. In step 1040, the second adhesive 203 of appliqué 200 is contacted with the substrate 100. One or both of heat and pressure are concurrent with the contacting or after the contacting. The applying of the heat, pressure or both adheres appliqué 200 to the substrate 100.

In some configurations of step 1040, decorative article 700 is formed. In step 1040, the second adhesive 203 of transfer 600 is contacted with the substrate 100. One or both of heat and pressure are concurrent with the contacting or after the contacting. The applying of the heat, pressure or both adheres appliqué 200 to the substrate 100. In some configurations of step 1040, the transfer sheet 601 with release adhesive 602 is removed from decorative article 700 to form decorative article 500.

The present disclosure, in various aspects, embodiments, and configurations, includes components, methods, processes, systems and/or apparatus substantially as depicted and described herein, including various aspects, embodiments, configurations, sub-combinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An article, comprising:
a decorative element selected from the group consisting of flock, a woven textile, a knitted textile, a metalized film, or a combination thereof;
a support layer positioned between first and second adhesives, wherein the support layer has a support layer areal extent and the second adhesive is in contact with all of the support layer areal extent; and
a substrate having a surface disruption, wherein the second adhesive is positioned between the substrate and the support layer in contact with the surface disruption, wherein the first adhesive is positioned between the decorative element and the support layer and wherein the surface disruption is not imaged within the decorative element and is not perceived by a view of the decorative element.

2. The article of claim 1, wherein the substrate comprises an item of apparel.

3. The article of claim 2, wherein the surface disruption is a seam.

4. The article of claim 1, wherein the decorative element is a metalized film comprising a polyurethane.

5. The article of claim 1, wherein decorative element comprises a combination of two or more of the flock, woven textile, and metalized film.

6. The article of claim 5, wherein at least two of the two or more of the flock, woven textile and metalized film are arranged side by side.

7. The article of claim 5, wherein at least two of the two or more of the flock, woven textile and metalized film are arranged one on top of the other.

8. The article of claim 1, wherein the first adhesive is one of a thermoplastic adhesive, a thermosetting adhesive, or a combination of a thermoplastic adhesive and a thermosetting adhesive and wherein the second adhesive is one of a thermoplastic adhesive, a thermosetting adhesive, or a combination of a thermoplastic adhesive and a thermosetting adhesive.

9. The article of claim 1, further comprising:
a carrier adhered to the decorative element by a release adhesive.

10. The article of claim 1, wherein the support element comprises polycarbonate.

11. The article of claim 1, wherein the support element has one or more of the following properties:
(a) a tensile strength from about 55 to about 75 MPa;
(b) a tensile modulus from about 1,800 to about 2,400 MPa;
(c) a thickness from about 0.1 to 0.8 mm; and
(d) a softening temperature greater than 145 degrees Celsius.

12. A method, comprising:
providing a decorative element;
providing a support element;
adhering the decorative element to the support element with a first adhesive, wherein the first adhesive is provided separately or with one of the decorative element or the support element;
providing a substrate having a surface disruption; and
adhering the decorative element to a substrate by a second adhesive, wherein the substrate has a surface disruption, wherein the is provided separately or with the support element, wherein the support element has a support element areal extent and the second adhesive is in contact with all of the support element areal extent, wherein the second adhesive is in contact with surface disruption and wherein the surface disruption is not imaged within the decorative element.

13. The method of claim 12, wherein one or both of the adhering the decorative element to the support element with a first adhesive and the adhering the decorative element to a substrate by a second adhesive further comprises:
applying one or both of heat and pressure the adhering step.

14. The method of claim 12, wherein an image of the surface disruption is not perceived within the decorative by a view of the decorative element

15. The method of claim 12, wherein the support element comprises polycarbonate.

16. The method of claim 12, wherein the support element has one or more of the following properties:
(a) a tensile strength from about 55 to about 75 MPa;
(b) a tensile modulus from about 1,800 to about 2,400 MPa;
(c) a thickness from about 0.1 to 0.8 mm; and
(d) a softening temperature greater than 145 degrees Celsius.

17. The method of claim 12, wherein the substrate comprises an item of apparel.

18. The method of claim 17, wherein the surface disruption is a seam.

19. The article of claim 12, wherein the decorative element is a metalized film comprising a polyurethane.

20. The method of claim 12, wherein decorative element comprises a combination of two or more of the flock, woven textile, and metalized film.

21. The method of claim 20, wherein at least two of the two or more of the flock, woven textile and metalized film are arranged side by side.

22. The method of claim 20, wherein at least two of the two or more of the flock, woven textile and metalized film are arranged one on top of the other.

23. The method claim 12, wherein the decorative element is provided with the first adhesive.

24. The method claim 12, wherein the supported layer is provided with the first and second adhesives and wherein the support element is positioned between the first and second adhesives.
